(19) United States
(12) Patent Application Publication
(10) Pub. No.: US 2014/0344129 A1
(43) Pub. Date: Nov. 20, 2014

(54) CENTRALIZED ENTITLEMENTS

(71) Applicant: Bottomline Technologies (DE) Inc., Portsmouth, NH (US)

(72) Inventors: Eric Campbell, Rye, NH (US); Robert F. Hoffman, Baldwin, NY (US)

(73) Assignee: Bottomline Technologies (DE) Inc., Portsmouth, NH (US)

(21) Appl. No.: 13/896,885

(22) Filed: May 17, 2013

(51) Int. Cl. G06Q 20/02

(52) U.S. Cl. CPC G06Q 20/02; G06Q 40/02
USPC 705/35

(57) ABSTRACT

A method and central entitlement server are presented for centrally storing and providing entitlements to subscribing application servers. The subscribing application servers provide services to bank accounts held by corporate customers. Services are requested by corporate customer users and in service requests. Prior to performing a requested service, the subscribing application servers verify that the requesting corporate customer user has permission to request the service on the account identified in the service request. The subscribing application servers verify requested services using entitlements received from the central entitlement server. Services that can be requested are stored in a hierarchical data structure. The hierarchical data structure includes at least one product as a root. Each product is linked to at least one product function, each product function is linked to at least one function type, each function type is linked to an action, and each action corresponds to a service.

### TECHNICAL FIELD

The present invention relates to electronic delivery of entitlements and, more particularly, to a central entitlement server for providing entitlements to subscribing application servers that are operated by third parties and are responsible for providing services to bank accounts of corporate customers.

### BACKGROUND OF THE INVENTION

Increasingly banks rely on third parties to perform bank offered services for corporate accounts (e.g., international wire transfers). In order for third parties to ensure that service requests are coming from users with sufficient privileges to request the services, the third parties must have access to an up to date entitlement database. The diversity of entitlement formats used by third parties, the number of third party service providers, and the different types of services provided by third parties require significant time investments to convert a bank held entitlement database into a format readable by different third parties.

Corporate customers of banks typically have multiple users, with individual users having privileges to request the performance of varying number of services on corporate customer accounts. Often, subscribing application servers operated by third parties perform services that appear to be provided by a bank (e.g., wire transfers). When a subscribing application server receives a request to perform an action on a bank account, the subscribing application server should be able to determine if the requesting party has sufficient privileges to request the service.

A bank typically maintains a record of privileges (i.e., entitlements) available to different corporate customers and their users. As entitlements change (i.e., are updated), bank employees typically must manually change the entitlements associated with corporate customer users. In order to ensure efficient updating of the database, banks group related services. The grouping of services varies between banks and third party service providers, making it difficult for banks to pass entitlements to third parties in a readable format.

Thus, there exists a need for a method, central entitlement server, and subscribing application server for passing entitlements in a format that is readable by both third party service providers and banks.

### SUMMARY OF THE INVENTION

The present invention provides a central entitlement server for centrally storing and providing entitlements to subscribing application servers, enabling each subscribing application server to verify a corporate customer user has permission to request application of a given service to an account associated with the corporate customer, the subscribing application servers providing services to accounts held by corporate customers at a bank.

A first aspect of the present invention relates to a central entitlement server for centrally storing and providing entitlements to subscribing application servers. Each subscribing application server provides services to accounts held by corporate customers at a bank, the corporate customer designating at least one corporate customer user. The server includes a database encoded to a non-transitory computer readable memory storing the entitlements. Each entitlement relates to at least one corporate customer user and specifies at least one associated account and at least one approved service the at least one corporate customer user has permission to request. Each at least one approved service is one of a plurality of possible services and is mapped to a hierarchical data structure of services. The hierarchical data structure of services includes at least one product. The at least one product is a root and each product is a parent of and links to at least one product function. Each product function links to at least one function type. The product function is a parent of the at least one function type. Each function type links to at least one action. The function type is a parent of the at least one action. Each action corresponds to one of the plurality of possible services. Each of the plurality of possible services are represented by a corresponding action. Each action is identified as approved if the at least one corporate customer user has permission to request the service corresponding to the action or disapproved if the at least one corporate customer user does not have permission to request the service corresponding to the action. The server also includes a processor and a network interface. The processor is configured to determine the entitlements associated with each subscribing application server and instruct a network interface to send each subscribing application server the entitlements stored in the database that are associated with the subscribing application server. The network interface is configured to receive the instruction from the processor and send each subscribing application server the entitlements associated with the subscribing application server.

Additionally or alternatively, at least one action is a restricted action. Each restricted action linking to at least one restriction. Each restriction places a limitation on performance of the restricted action.

Additionally or alternatively, the limitation placed by each restriction is at least one of a limit to the number of times the restricted action can be performed in a period of time, a prohibition on performing the restricted action when the restricted action affects a dollar amount above a threshold, and a requirement that the restricted action be approved by a corporate customer user having supervisory authority.

Additionally or alternatively, at least two function types are grouped into a function group.

Additionally or alternatively, at least two actions are grouped into an entry method.

Additionally or alternatively, at least two corporate customer users are associated with a user group, a group entitlement is associated with the user group, and the group entitlement specifies at least one associated account and at least one approved service the at least two corporate customer users have permission to request. Each at least one approved service is one of plurality of possible services stored in the hierarchical data structure of services.

Additionally or alternatively, the processor instructs the network interface to send each subscribing application server the entitlements associated with the subscribing application server at a scheduled time.

Additionally or alternatively, the processor instructs the network interface to send a given subscribing application server the entitlements associated with the given subscribing application server after the network interface receives a request from the given subscribing application server.

Additionally or alternatively, the processor instructs the network interface to send a given subscribing application server only the entitlements associated with the given subscribing application server that have changed since a previous sending of entitlements to the given subscribing application server.

Additionally or alternatively, when sending each subscribing application server the entitlements associated with the subscribing application server the network interface sends each entitlement as a separate data structure identifying the at least one corporate customer user, the at least one associated account, and the at least one approved service the at least one corporate customer user has permission to request.

Additionally or alternatively,

Another aspect of the present invention relates to a subscribing application server providing at least one service to a corporate customer. A corporate customer user requests application of a given service of the at least one service to an account associated with the corporate customer at a bank. The subscribing application server includes a network interface, a database, and a processor. The network interface receives entitlements. The database is encoded to a non-transitory computer readable memory storing the entitlements. Each entitlement relates to at least one corporate customer user and specifies at least one associated account and at least one approved service the at least one corporate customer user has permission to request. Each at least one approved service is one of a plurality of possible services and is mapped to a hierarchical data structure of services. The hierarchical data structure of services includes at least one product. The at least one product is a root and each product is a parent of and links to at least one product function. Each product function links to at least one function type. The product function is a parent of the at least one function type. Each function type links to at least one action. The function type is a parent of the at least one action. Each action corresponds to one of the plurality of possible services. Each of the plurality of possible services are represented by a corresponding action. Each action is identified as approved if the at least one corporate customer user has permission to request the service corresponding to the action or disapproved if the at least one corporate customer user does not have permission to request the service corresponding to the action. The network interface is further configured to receive a service request from a given corporate customer user. The service request includes a requested service to be performed on a specified account. The processor is configured to access the entitlement stored in the database for the given corporate user to determine if the given corporate customer user has permission to request performance of the requested service on the specified account. If the given corporate customer user is determined to have permission, the processor performs the requested service on the specified account.

Additionally or alternatively, at least one action is a restricted action, each restricted action linking to at least one restriction, each restriction placing a limitation on performance of the restricted action.

Additionally or alternatively, the limitation placed by each restriction is at least one of a limit to the number of times the restricted action can be performed in a period of time, a prohibition on performing the restricted action when the restricted action affects a dollar amount above a threshold, and a requirement that the restricted action be approved by a corporate customer user having supervisory authority.

Additionally or alternatively, at least two function types are grouped into a function group.

Additionally or alternatively, at least two actions are grouped into an entry method.

Additionally or alternatively, at least two corporate customer users are associated with a user group, a group entitlement is associated with the user group, and the group entitlement specifies at least one associated account and at least one approved service the at least two corporate customer users have permission to request, wherein each at least one approved service is one of plurality of possible services stored in the hierarchical data structure of services.

Additionally or alternatively, the processor is further configured to instruct the network interface to send a request for an entitlement update.

Additionally or alternatively, the processor instructs the network interface to send the request after the network interface receives the service request.

Additionally or alternatively, the processor instructs the network interface to send the request at a scheduled time.

Additionally or alternatively, the approved services in each received entitlement are not contained in the hierarchical data structure of services and the processor is further configured to map the approved services in the received entitlements to the hierarchical data structure of services for storage in the database.

Still another aspect of the present invention relates to a method for centrally storing entitlements in a central entitlement server and sending the entitlements from the central entitlement server to subscribing application servers. The subscribing application servers performing services on accounts at a bank based on the entitlements and received service requests. The method includes sending entitlements, over a network from the central entitlement server, to the subscribing application servers. Each entitlement relates to at least one corporate customer user and specifies at least one associated account and at least one approved service the at least one corporate customer user has permission to request. Each at least one approved service is one of a plurality of possible services and is mapped to a hierarchical data structure of services. The hierarchical data structure of services includes at least one product. The at least one product is a root and each product is a parent of and links to at least one product function. Each product function links to at least one function type. The product function is a parent of the at least one function type. Each function type links to at least one action. The function type is a parent of the at least one action. Each action corresponds to one of the plurality of possible services. Each of the plurality of possible services are represented by a corresponding action. Each action is identified as approved if the at least one corporate customer user has permission to request the service corresponding to the action or disapproved if the at least one corporate customer user does not have permission to request the service corresponding to the action. The method also includes receiving, by at least one subscribing application server, a service request sent by a given corporate customer user, the service request including a requested service to be performed on a specified account. The method further includes validating by the subscribing application server that the given corporate customer user has permission to request the requested service. Validation includes analyzing the entitlement associated with the given corporate user to determine if the given corporate customer user has permission to request performance of the requested service on the specified account and performing the requested service on the specified account if the corporate customer user is determined to have permission.

A number of features are described herein with respect to embodiments of the invention; it will be appreciated that features described with respect to a given embodiment also may be employed in connection with other embodiments.

For a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is a block diagram representing the architecture of a central entitlement server, multiple subscribing application servers, and a web portal in accordance with an exemplary embodiment of the present invention;

FIGS. 2A and 2B are diagrams representing hierarchical data structures of services in accordance with exemplary embodiments of the present invention;

FIG. 2B is a diagram representing a hierarchical data structure of services in accordance with an exemplary embodiment of the present invention;

FIG. 3 is a diagram representing an exemplary service request;

FIGS. 4A-4F are diagrams of products, product functions, function types, actions, and restrictions in the hierarchical data structure in accordance with exemplary embodiments of the present invention;

FIG. 5 is a diagram of an entitlement for a user group in accordance with an exemplary embodiment of the present invention;

FIG. 6 is a diagram of an entitlement for a role in accordance with an exemplary embodiment of the present invention;

FIGS. 7A and 7B are ladder diagrams representing operation of the central entitlement server and subscribing application server in accordance with an exemplary embodiment of the present invention; and

FIG. 8 is a ladder diagram representing operation of the central entitlement server and two subscribing application servers in accordance with an exemplary embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present invention provides a method and central entitlement server for centrally storing and providing entitlements to subscribing application servers. The subscribing application servers provide services (e.g., international wire transfers) to accounts held by corporate customers at a bank. The services are requested by corporate customer users and transferred to the subscribing application servers as service requests. Prior to performing a requested service in a service request, the subscribing application servers verify that the requesting corporate customer user has permission to request the requested service on the account identified in the service request. The subscribing application servers verify each requested service using entitlements received from the central entitlement server. The services that can be requested (i.e., the possible requested services) are stored in a hierarchical data structure of services. The hierarchical data structure includes at least one product as a root. Each product is linked to at least one product function, each product function is linked to at least one function type, each function type is linked to at least one action, and each action corresponds to a service.

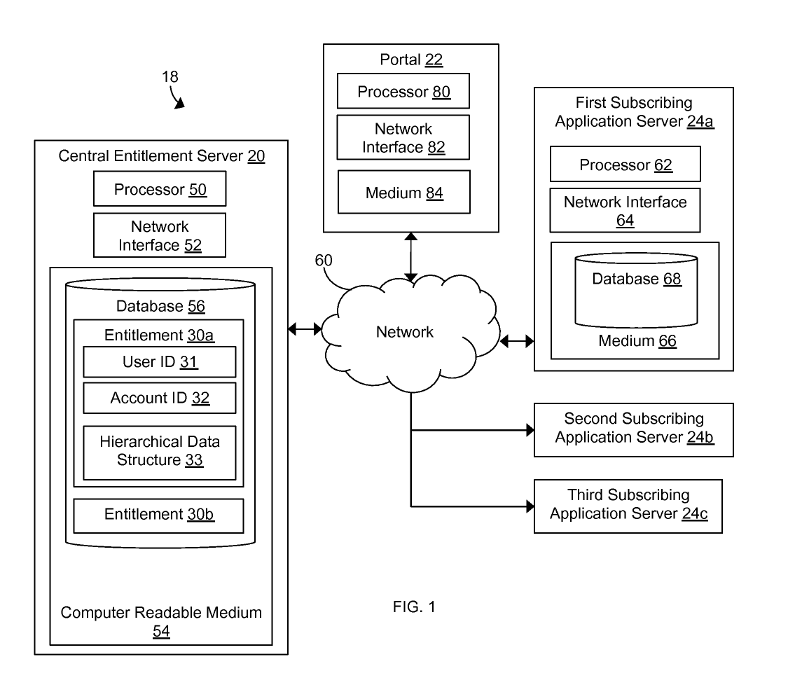

An exemplary centralized entitlement system 18 including a central entitlement server 20 and a first subscribing application server 24a are depicted in FIG. 1. The exemplary centralized entitlement system 18 may include a web portal 22, a second subscribing application server 24b, and a third subscribing application server 24c. A corporate customer may have an account (referred to as an associated account) at a bank. The corporate customer may have multiple users with varying levels of permission to access different accounts held by the corporate customer. Each corporate customer user may also have varying levels of permission to request the performance of actions on the different accounts. The central entitlement server 20 stores the permissions associated with each corporate customer user as entitlements. By, e.g., accessing the web portal 22, a corporate customer user may request application of a given service (i.e., an action) to an account associated with the corporate customer (e.g., a funds transfer or balance inquiry). The bank may use subscribing application servers 24a-24c operated by third parties to perform the requested action. Prior to performing a requested service on a designated account, the subscribing application server 24 determines if the requesting corporate customer user has permission to request the requested service on the designated account. The subscribing application server 24 determines if the corporate customer user has permission to request the requested service on the designated account by accessing the entitlement associated with the corporate customer user. The central entitlement server 20 provides the entitlements to the subscribing application servers 24a-24c so that the subscribing application servers 24a-24c have an up to date list of corporate customer user permissions.

With continued reference to FIG. 1, the central entitlement server 20 stores and provides entitlements 30 to the subscribing application servers 24. Each entitlement 30 relates to at least one corporate customer user (identified by a corporate customer user identifier 31) and specifies at least one associated account (identified by an account identifier 32) and at least one approved service the at least one corporate customer user has permission to request. Each at least one approved service stored in an entitlement 30 is one of a plurality of possible services and is mapped to a hierarchical data structure of services 33. Each of the plurality of possible services are represented by a corresponding action in the hierarchical data structure 33. Each action in the hierarchical data structure corresponds to one of the plurality of possible services and is identified as approved if the at least one corporate customer user has permission to request the service corresponding to the action. If the at least one corporate customer user does not have permission to request the service corresponding to the action, the action is identified as unapproved.

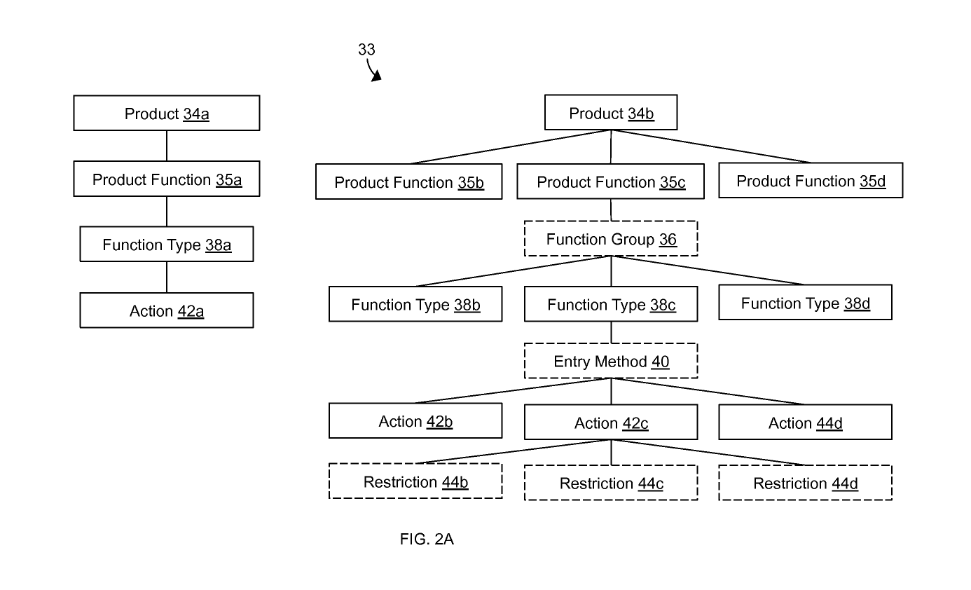

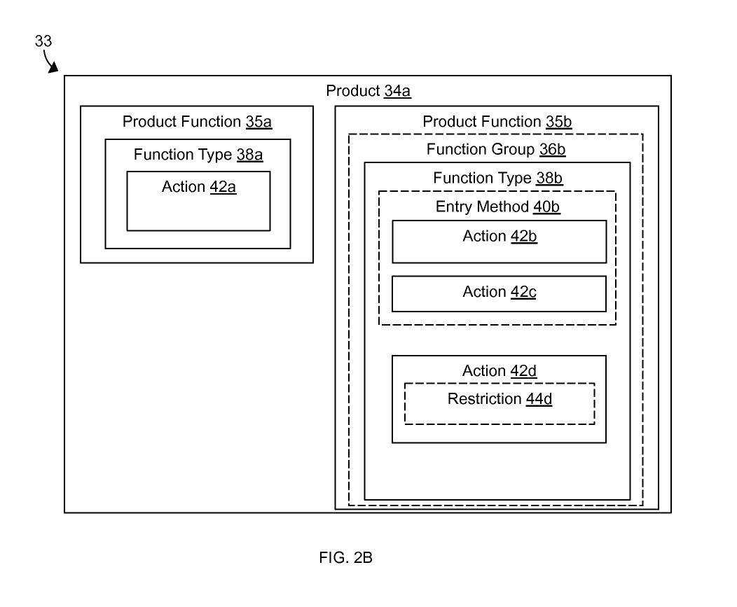

For purposes of visualization, e.g., the hierarchical data structure 33 may be viewed as a tree (FIG. 2A) or a record (FIG. 2B). The hierarchical data structure 33 includes at least one product 34. As shown in FIG. 2A, when viewed as a tree, each product 34 is a root. As shown in FIG. 2B, when viewed as a record, each product is the highest-level field of the record, with other fields contained within the product field. FIG. 2A contains two products 34a, 34b, while FIG. 2B contains a single product 34a.

As used herein, the term data structure is used to describe a particular way of storing and organizing data in a computer. Referring to a product 34 as a root is not meant to imply that the hierarchical data structure 33 must have a tree structure or that there is only one product. Rather, identifying a product 34 as a root indicates that the product is the top level of the hierarchical data structure 33. The hierarchical data structure 33 may have multiple products 34 (and thus multiple roots) as depicted in FIG. 2A.

As shown in FIGS. 2A and 2B, each product is a parent of and links to at least one product function 35. As used in this application, the terms “links to” and “parent of” are not meant to imply that the hierarchical data structure 33 must have a tree structure. Rather, as will be understood by a person of ordinary skill in the art, the hierarchical data structure 33 may have any suitable hierarchical structure. Thus, “links to” may be viewed as synonymous with, e.g., “contains” or “points to”. Similarly, as used in this application, “parent of” may take any meaning indicating that, in a hierarchical structure, the parent is at a higher level in the hierarchical structure than the child. In FIG. 2A, the product 34a links to and is the parent of a single product function 35a, while product 34b links to and is the parent of three product functions 35b-35d. In FIG. 2B, the sole product 34a links to and is the parent of two product functions 35a, 35b.

Each product function 35 links to at least one function type 38 and the product function 35 is a parent of the at least one function type 38. In some embodiments, the term “links to” is meant to require one element of the hierarchical data structure 33 to directly connect to another element. For example, FIG. 2A depicts a first product function 35a that directly links to and is the parent of a single function type 38a. Similarly, FIG. 2B depicts a product function 35a that directly links to a function type 38a.

In other embodiments the term “links to” is not meant to require one element of the hierarchical data structure 33 to directly connect to another element. That is, a first element may be linked to a third element through a second element. For example, in FIG. 2A, product function 35c is linked to function types 38b-38d through a function group 36. Also, in FIG. 2B, product function 35b is linked to function type 38b through function group 36b. Function groups 36 are optional members of the hierarchical data structure 33 that link or group at least two function types 38b-38d. For example, a function group 36 may group function types 38 having similar functions or characteristics.

Due to space constraints two product functions 35b, 35d in FIG. 2A are not shown as linking to a function type 38. This is not meant to imply that the two product functions 34b, 34d are not linked to a function type 38.

As shown in FIGS. 2A and 2B, each function type 38 links to and is the parent of at least one action 42. In FIG. 2A, function type 38a links directly to and is the parent of action 42a, while function type 38c links to actions 42b-42d through entry method 40. Entry methods 40 are optional members of the hierarchical data structure 33 that may group or link at least two actions 42b-42d. For example, entry methods may group actions that have a similar purpose or function. In FIG. 2B, function type 38b links directly to action 42d and links through entry method 40 to actions 42b and 42c, while function type 38a links directly to action 42a.

Due to space constraints function types 38b and 38d are not shown as linking to an action 42. This is not meant to imply that the two function types 38b, 38d are not linked to an action 42.

In FIG. 2A, action 42c is a restricted action. That is, action 42c links to at least one restriction 44b-44d. Each restriction 44b-44d places a limitation on performance of the restricted action 42c. For example, the limitation placed by each restriction may be at least one of a limit to the number of times the restricted action can be performed in a period of time, a prohibition on performing the restricted action when the restricted action affects a dollar amount above a threshold, and a requirement that the restricted action be approved by other corporate customer users (e.g., having supervisory authority). As will be understood by one of ordinary skill, limitations on restricted actions are not limited to those listed above.

Turning again to FIG. 1, the central entitlement server 20 may be a computer system of one or more servers comprising at least a processor 50, a network interface 52, and computer readable medium 54. The computer readable medium 54 includes encoded thereon a database 56 storing entitlements 30a, 30b. The database 56 may also include other data structures, also referred to as tables, as described herein and may include instructions embodied on the computer readable medium 54 for interfacing with the network interface 52 and computer programs for reading and writing data to the data structures and tables. The computer readable medium 54 may also include computer programs comprising instructions embodied on computer readable medium 54 and executed by the processor 50.

The network interface 52 may be communicatively coupled to multiple subscribing application servers 24a-24c and the web portal 22 via a network 60. The network 60 may be an open network, such as the Internet, a private network, such as a virtual private network, or any other suitable network. The network interface 52 may be configured to receive entitlements from the processor and/or computer readable medium 54 and send each subscribing application server 24a-24c only the entitlements associated with the subscribing application server. Alternatively, the network interface 52 may be configured to send each subscribing application server 24a-24c all of the entitlements stored on the computer readable medium 54 or a portion of all of the entitlements stored on the computer readable medium 54 regardless of which subscribing application server 24a-24c is associated with each entitlement 30. For example, if the computer readable medium 54 contains ten entitlements, the first five entitlements associated with the first subscribing application server 24a and the last five entitlements associated with the second subscribing application server 24b, the network interface 52 may send all ten entitlements to both subscribing application servers 24a, 24b. Alternatively, the network interface 52 may be configured to send only those entitlements 30 to the subscribing application servers 24 that have changed since the last update of the entitlements on the subscribing application servers 24.

The network interface 52 may communicate entitlements to subscribing application servers 24 using an application programming interface custom to the vendor, service provisioning markup language (SPML) messages, or web services calls. For example, using SPML, the network interface 52 may broadcast all entitlement 30 changes to all subscribing application servers 24 able to accept SPML messages. In another example, the subscribing application servers 24 may send a request for an entitlement update to the central entitlement server 20. Upon receiving the request for entitlement update, the central entitlement server 20 may send an updated list of entitlements to the requesting subscribing application server. In yet another example, for subscribing application servers that do not support SPML and/or are unable to make web service calls, the central entitlement server 20 may include a product specific application interface for communicating entitlements to the subscribing application server.

As will be understood by one of ordinary skill in the art, the network interface 52 may comprise a wireless network adaptor, an Ethernet network card, or any suitable device that provides an interface between the central entitlement server 20 and the network 60. The network interface 52 may be communicatively coupled to the computer readable medium 54, such that the network interface 52 is able to send data stored on the computer readable medium 54 across the network 60 and store received data on the computer readable medium 54. The network interface 52 may also be communicatively coupled to the processor 50 such that the processor is able to control operation of the network interface 52. The network interface 52, computer readable medium 54, and processor 50 may be communicatively coupled through a system bus, mother board, or using any other suitable manner as will be understood by one of ordinary skill in the art.

As will be understood by one of ordinary skill in the art, the database 56 may describe a data structure which embodies groups of records or data elements stored in a volatile or non volatile storage medium and accessed by an application, which may be instructions coded to a storage medium and executed by a processor. The database may comprise multiple individual databases stored on the same storage medium or on multiple different storage media. The central entitlement server 20 may also store data in and access the database 56. While the database 56 is depicted as a component of the central entitlement server 20 in FIG. 1, the database 56 could alternatively be stored on a separate server or locally, e.g., on the web portal 22.

The processor 50 may be configured to determine the entitlements 30 associated with each subscribing application server 24a-24c and instruct the network interface 52 to send each subscribing application server 24a-24c the entitlements 30 stored in the database 56 that are associated with the subscribing application server 24a-24c. The processor 50, network interface 52, and non-transitory computer readable medium 54 may be communicatively coupled through a system bus, mother board, or using any other suitable structure. The communicative coupling may allow the processor 50 to control operation of the network interface 52 and computer readable medium 54.

As will be understood by one of ordinary skill in the art, the processor 50 may have various implementations. For example, the processor 50 may include any suitable device, such as a programmable circuit, integrated circuit, memory and I/O circuits, an application specific integrated circuit, microcontroller, complex programmable logic device, other programmable circuits, or the like. The processor 50 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor. The processor 50 may be communicatively coupled to the computer readable medium 54 and network interface 52 through a system bus, mother board, or using any other suitable structure known in the art.

With further reference to FIG. 1, in an exemplary embodiment, each subscribing application server 24a-24c may be operated by a third party separate from the bank and may include at least one computer system or server. As described above, each subscribing application server 24a-24c provides at least one service to a corporate customer of the bank. Each subscribing application server 24a-24c includes a processor 60, a network interface 64, and a non-transitory computer readable medium 66. The processor 60, network interface 64, and non-transitory computer readable medium 66 may be communicatively coupled through a system bus, mother board, or using any other suitable structure. The communicative coupling may allow the processor 60 to control operation of the network interface 64 and computer readable medium 66. For example, the processor 60 may instruct the computer readable medium 66 to store data received by the network interface 64. The processor 60 may also instruct the network interface 64 to send data stored in the computer readable medium 66. The processor 60 may also access data stored in the computer readable medium 66.

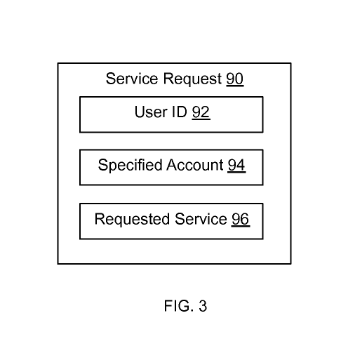

The network interface 64 may be communicatively coupled to the central entitlement server 20 and the web portal 22 via a network 60. The network interface 64 may be configured to receive entitlements 30, e.g., from the central entitlement server 20 and service requests from, e.g., a given corporate customer user. An exemplary service request 90 is depicted in FIG. 3. The service request 90 includes an identification of the corporate customer user requesting the service 92, a requested service 96, and a specified account 94 on which the requested service 92 is to be performed. The network interface 64 may store received entitlements 30 in a database 68 encoded to the non-transitory computer readable memory 66.

As will be understood by one of ordinary skill in the art, the network interface 64 may comprise a wireless network adaptor, an Ethernet network card, or any suitable device that provides an interface between the subscribing application server 64 and the network 60.

As will be understood by one of ordinary skill in the art, the database 68 may describe a data structure which embodies groups of records or data elements stored in a volatile or non volatile storage medium and accessed by an application, which may be instructions coded to a storage medium and executed by a processor. The database may comprise multiple individual databases stored on the same storage medium or on multiple different storage media. The subscribing application server may also store data in and access the database 68. While the database 68 is depicted as a component of the subscribing application server 24 in FIG. 1, the database 68 could alternatively be stored on a separate server.

The processor 62 is configured to determine if the given corporate customer user 92 has permission to request performance of the requested service 96 on the specified account 94. In order to make this determination, the processor 62 is configured to access the entitlement 30 stored in the database 68 for the given corporate user 92 associated with the service request 90. If the given corporate customer user is determined to have permission, the processor performs the requested service on the specified account. A given corporate customer user is determined to have permission if the entitlement associated with the given corporate customer user indicates that the user has permission to request the requested service on the specified account. The processor 62 performing the requested service may include the processor 62 causing the network interface 64 to send instructions to a separate server or computer system to perform the requested service on the account.

As will be understood by one of ordinary skill in the art, the processor 62 may have various implementations. For example, the processor 62 may include any suitable device, such as a programmable circuit, integrated circuit, memory and I/O circuits, an application specific integrated circuit, microcontroller, complex programmable logic device, other programmable circuits, or the like. The processor 62 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor.

With continued reference to FIG. 1, in an exemplary embodiment, the bank may operate the web portal 22. The portal 22 may include a processor 80, a network interface 82, and a non-transitory computer readable medium 84. The portal may be embodied as at least one computer system or server. The portal 22 may host the banks Internet website. By accessing the portal 22 over the network 60, a user may supply credentials to authenticate as a corporate customer user. Once authenticated, corporate customer users may initiate service requests. Additionally, through the portal 22, administrative users may update entitlements.

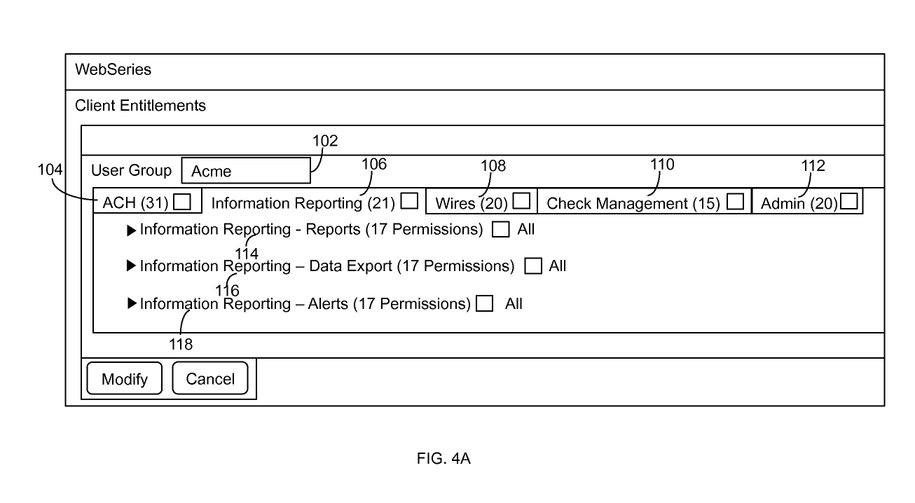

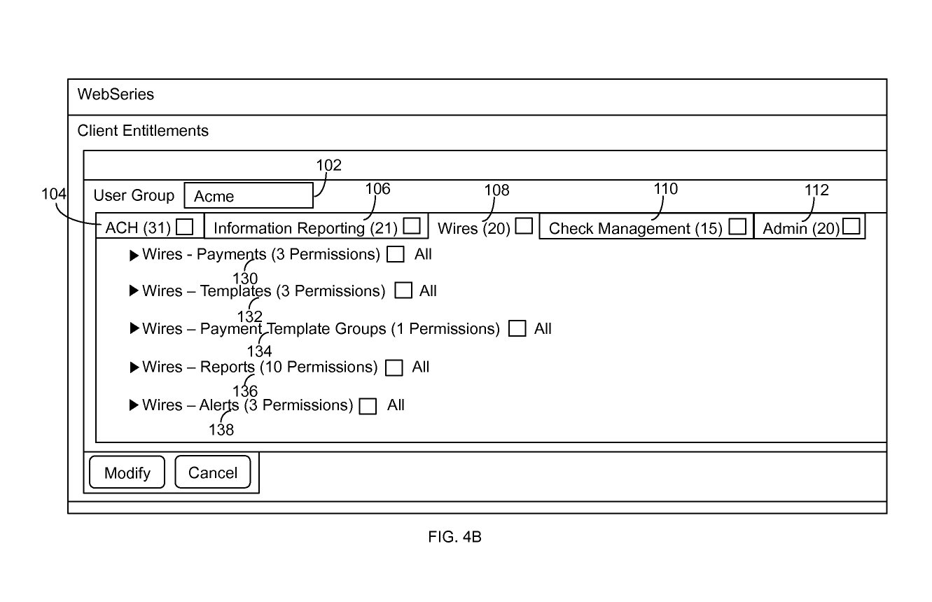

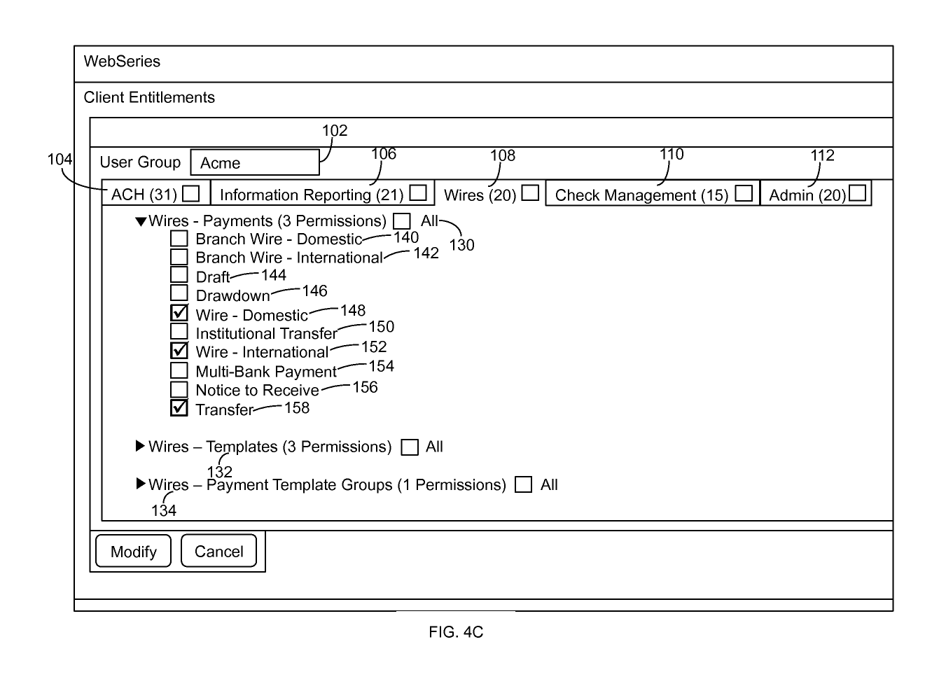

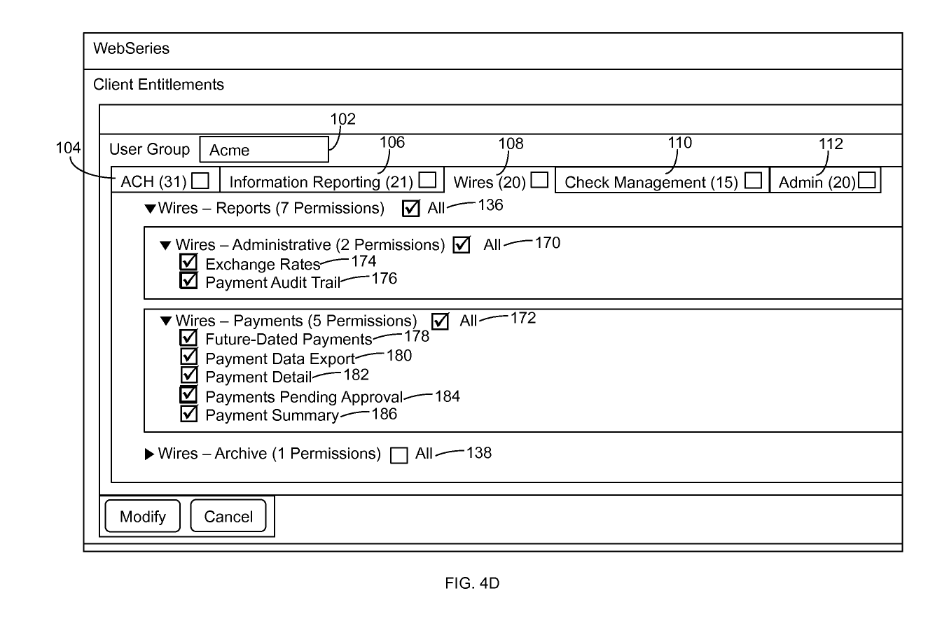

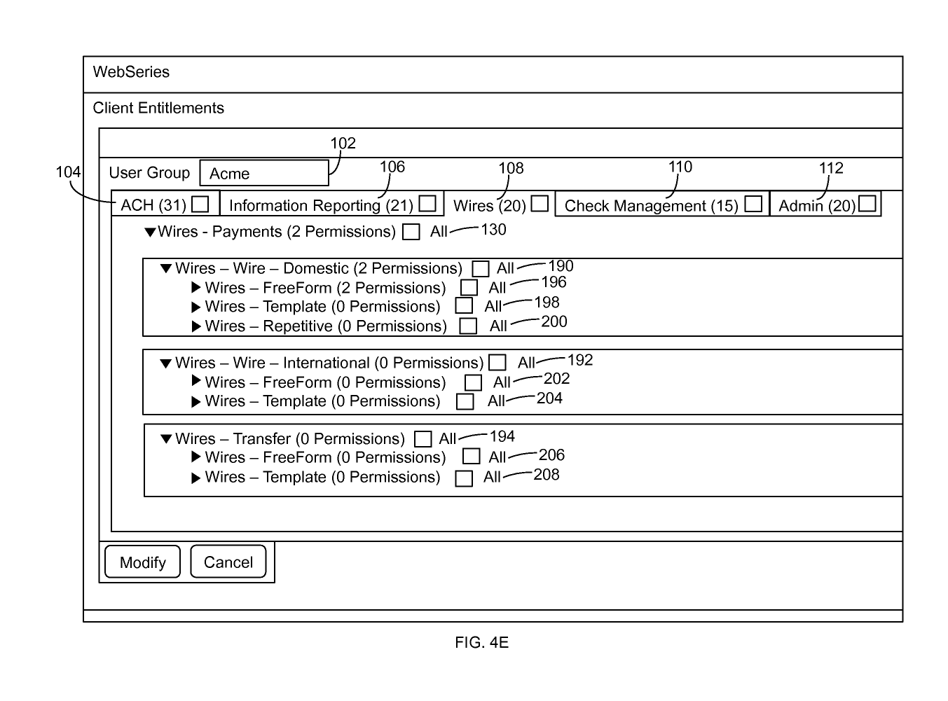

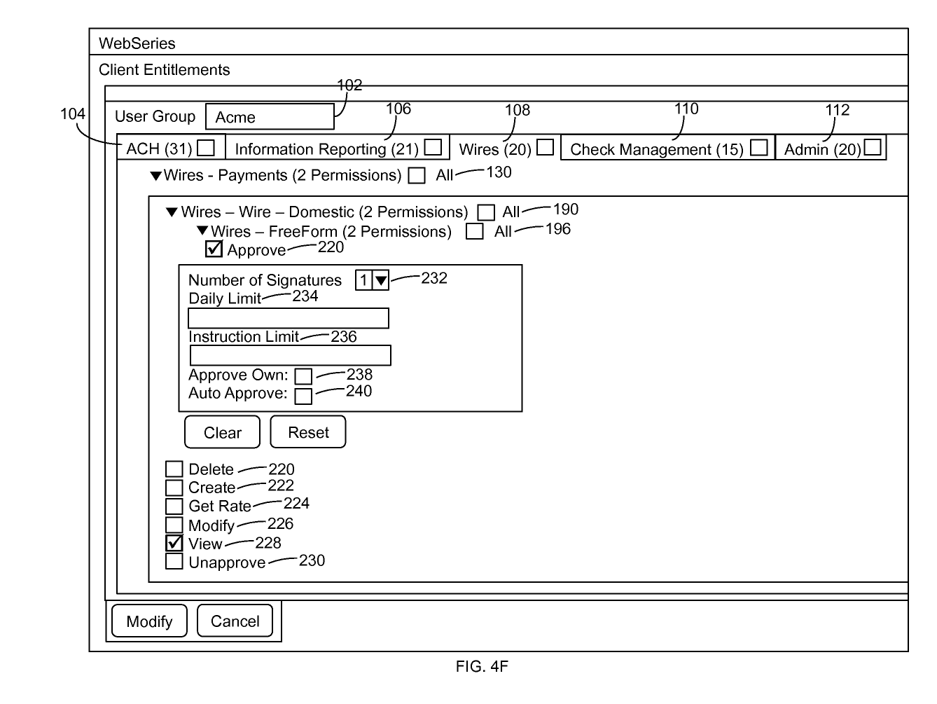

Turning to FIGS. 4A-4F, exemplary screen shots of entitlements viewed through, e.g., the portal 22 are shown. For example, FIG. 4A may depict an exemplary user interface visible by a bank administrator when modifying entitlements. Using the depicted user interface, a bank administrator may utilize the web portal 22 to associate accounts with corporate customers and entitle the corporate customers. For example, an administrative user may change permissions by adding a check mark or removing a check mark from the box following each product, product function, function group, function type, entry method, or action. A corporate customer user with administrative privileges may also utilize the web portal 22 to change and/or create new entitlements for other users of the corporate customer. For example, a chief financial officer of Acme (as an example of an administrative corporate user) may create a new corporate customer user associated with Acme having permission to make wire transfers from an account held by Acme.

With further reference to FIGS. 4A-4F, entitlements for a user group Acme 102 are shown. Each corporate customer is associated with at least one user group 102. For example, if Acme has three divisions (e.g., investments, manufacturing, and services), Acme may have a different user group 102 associated with each division or Acme may have a single user group 102 for all of Acme. In this example, Acme could have an investments user group, a manufacturing user group, and a services user group. Each user group includes at least one corporate customer user that is associated with the user group 102. A group entitlement associated with the user group 102 specifies at least one associated account and at least one approved service that the group members (i.e., corporate customer users) may have permission to request. A change to the entitlements assigned to the user group may affect the privileges of each corporate customer user that is a member of the user group.

With continued reference to FIGS. 4A-4F, five products 34 are visible: automated clearinghouse transfers 104, information reporting 106, wires 108, check management 110, and administration 112. In FIG. 4A, the product for information reporting 106 is expanded to display three product functions: reports 114, data export 116, and alerts 118. In FIG. 4B, the wires product 108 is expanded to show five product functions: payments 130, templates 132, payment template groups 134, reports 136, and alerts 138. The total number of permissions that user group Acme 102 has are indicated between parenthesis next to each product 102, 104, 106, 108, 110, 112 and each expanded product function 114, 116, 118, 130, 132, 134, 136, 138.

In FIG. 4C, the wires payments product function 130 is expanded to show ten function types: branch wire—domestic 140, branch wire—international 142, draft 144, drawdown 146, wire—domestic 148, institutional transfer 150, wire—international 152, multi-bank payment 154, notice to receive 156, and transfer 158. In the example, the user group Acme 102 has three permissions relating to the wires payments product functions. The three permissions are indicated by check marks for wire—domestic 148, wire—international 152, and transfer 158. The check marks next to a product function may indicate that the user group 102 has permission for all function types and actions within each designated product function. An administrative user may change permissions for the Acme user group 102 by adding or removing check marks next to the displayed product functions.

In FIG. 4D, the wires reports product function 136 is expanded to show two function groups: administrative 170 and payments 172. In the administrative function group 170 there are two function types: exchange rates 174 and payment audit trail 176. In the payments function group 172 there are five function types: future-date payments 178, payment data export 180, payment detail 182, payments pending approval 184, and payment summary 186. In this example, the Acme user group 102 has permission (indicated by check marks) for all of the function types in the two function groups 170, 172. Again, a user may remove permissions by removing the check marks following each function type.

In an alternative embodiment shown in FIG. 4E, the wires payments 130 product function is expanded to show three function types: wire—domestic 190, wire—international 192, and transfer 194. Each of the three function types 190, 192, 194 include entry methods. The wire—domestic 190 function type has three entry methods: freeform 196, template 198, and repetitive 200. The wire—international 192 function type has two entry methods: freeform 202 and template 204. The transfer 194 function type has two entry methods: freeform 206 and template 208.

In FIG. 4F, the freeform entry method 196 is expanded to show seven actions: approve 220, delete 220, create 222, get rate 224, modify 226, view 228, unapproved 230. The user group acme 102 has permission for actions approve 220 and view 224c as indicated by check marks. The action approve 220 has five restrictions: number of signatures 232, daily limit 234, instruction limit 236, approve own 238, and auto approve 240. In the depicted entitlement the only restriction is a requirement for a single signature.

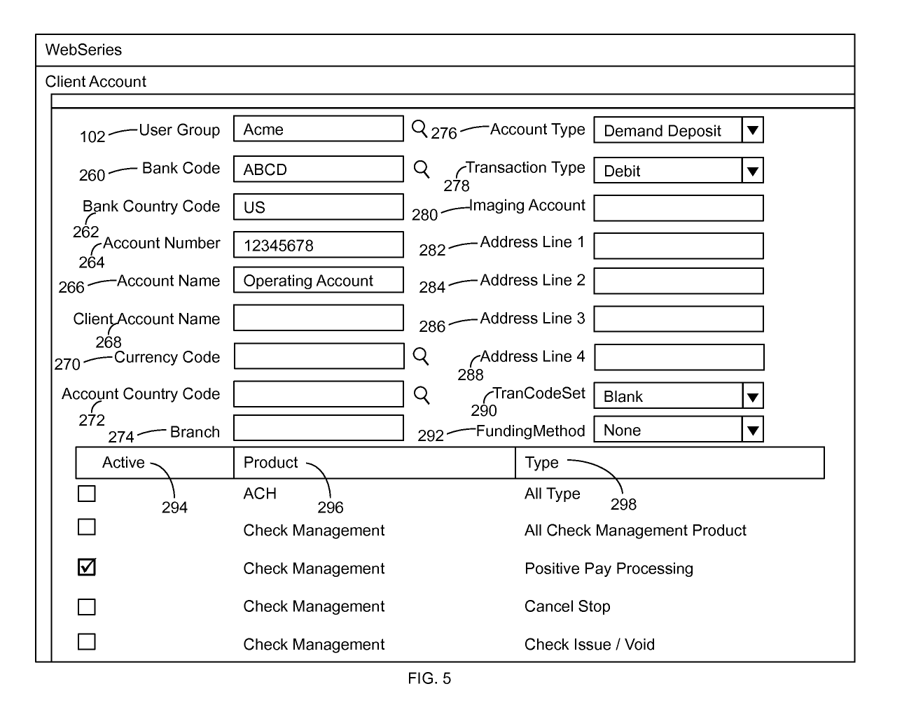

Turning to FIG. 5, an exemplary entitlement for a user group 102 associated with the corporate customer Acme is shown. The displayed entitlement includes fields for a bank code 260, bank country code 262, account number 264, account name 266, client account name 268, currency code 270, account country code 272, branch 274, account type 276, transaction type 278, imaging account 280, address line 1 282, address line 2 284, address line 3 286, address line 4 288, TranCodeSet 290, and Funding Method 292. The “Product” column 296 lists products 34, product functions 35, function types 38, and actions 42 that the user group 102 may or may not have permission to request. For a given element in the product column 296, the type column 298 describes the product. The “active” column 294 identifies the elements in the product column 296 that the user group 102 has permission to request. In the displayed entitlement the Acme user group 102 currently has access to “Check Management”—“Positive Pay Processing”.

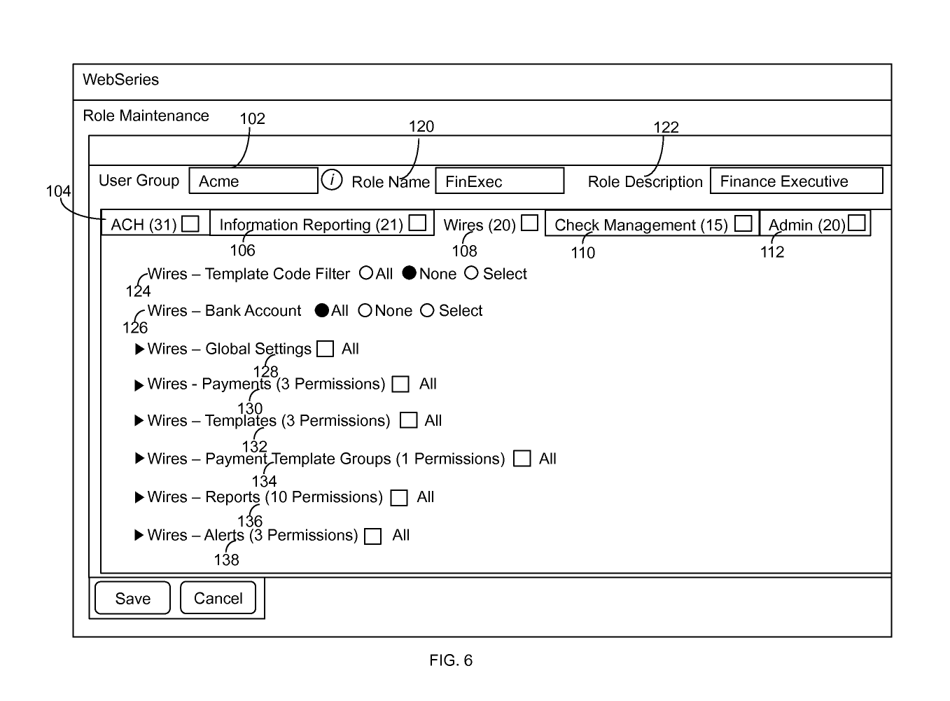

Turning to FIG. 6, an exemplary entitlement for a role associated with user group Acme 102 is shown. An administrative user of the corporate customer may change the entitlements of other corporate customer users using the displayed user interface. The displayed entitlement is for a role identified by the role name “FinExec” 120 and role description “Finance Executive” 122. Each role is associated with at least one user group 102 and is limited to the entitlements available to the user group 102 and the accounts associated with the user group. That is, each role may have as many permissions as the user group it is associated with, but may not have any permission is not available to the user group. In the example, the role has no entitlements related to “wires—template code filter” 124, but has all the entitlements available to user group Acme related to “wires—bank account” 126. Each corporate customer user is a member of at least one role. A change to the entitlements assigned to a role may affect the privileges of each corporate customer user that is a member of the role.

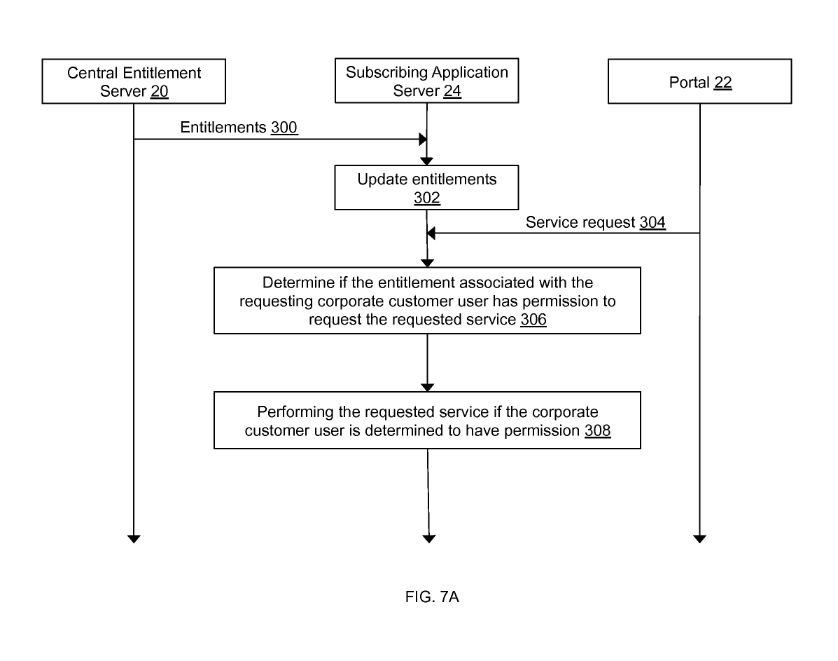

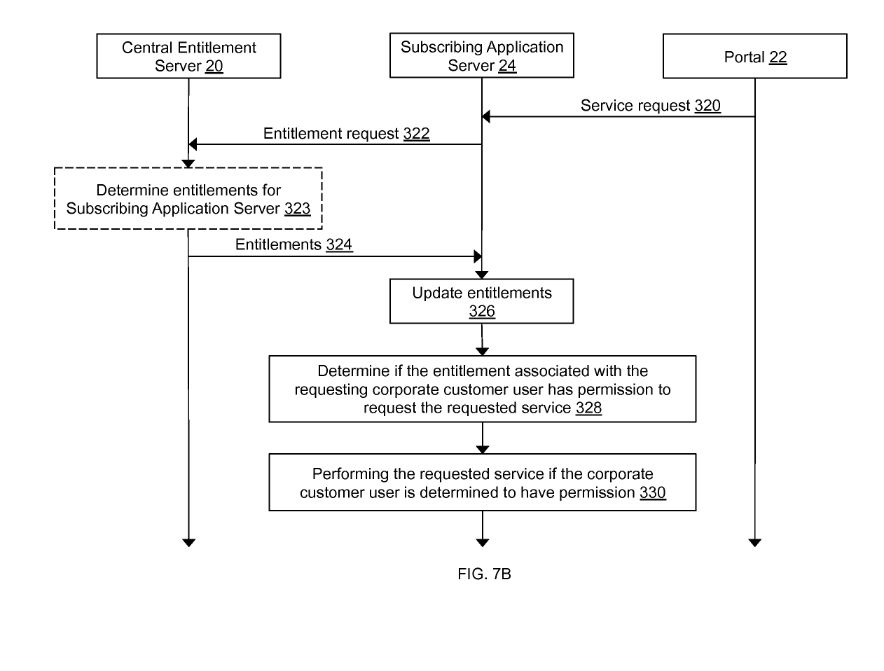

Turning to FIG. 7A, exemplary processing steps of the method for centrally storing entitlements in a central entitlement server and sending the entitlements from the central entitlement server to the subscribing application servers are shown in a ladder diagram. In step 300, the central entitlement server 20 sends entitlements over a network to the subscribing application server 24. The processor 50 may instruct the network interface 52, at a scheduled time, to send each subscribing application server 24 only the entitlements associated with the subscribing application server 24 or all of the entitlements. Alternatively, the processor 50 may instruct the network interface 52 to send a given subscribing application server only the entitlements associated with the given subscribing application server that have changed since a previous sending of entitlements to the given subscribing application server. The network interface 52 may send each entitlement as a separate data structure identifying the at least one corporate customer user, the at least one associated account, and the at least one approved service the at least one corporate customer user has permission to request. That is, in one embodiment the sent entitlements may not include a hierarchical data structure of services. Rather, the entitlements may include a listing of the services for which the associated users have permission to request. In this embodiment, once the subscribing application server 24 receives the entitlements, the subscribing application server maps the entitlements back into the hierarchical data structure for storage.

The subscribing application server 24 receives the entitlements and, in processing step 302, updates the entitlements stored in the subscribing application server 24. In step 304, the subscribing application server 24 receives a service request initiated by a given corporate customer user and including a requested service to be performed on a specified account. For example, the given corporate customer user may have initiated the service request at the web portal 22.

The subscribing application server 24 validates that the given corporate customer user has permission to request the requested service. Validation includes, as depicted in processing step 306, analyzing the entitlement associated with the given corporate user to determine if the given corporate customer user has permission to request performance of the requested service on the specified account. This analysis may comprise locating the entitlement associated with the given corporate customer user and locating within the hierarchical data structure of the entitlement the requested service in the hierarchical data structure to determine if the user is indicated as having permission to initiate the requested service. In processing step 308, if the corporate customer user is determined to have permission, the subscribing application server 24 performs the requested service on the specified account. Performance of the requested service by the subscribing application server 24 may comprise sending an instruction to another computer or server to perform the requested service on the specified account.

Turning to FIG. 7B, exemplary steps of another embodiment of the method are shown in a ladder diagram. In step 320, the subscribing application server 24 receives a service request 320. The service request may be received from the web portal 22. In step 322, the processor of the subscribing application server 24 instructs the network interface to send an entitlement request 322 to the central entitlement server 20. The subscribing application server 24 may send a request for an entitlement update after the network interface receives a service request and/or at a schedule time. The entitlement request may be a request for an entitlement update. In optional processing step 323, the central entitlement server determines the entitlements for the requesting subscribing application server. In step 324, the central entitlement server 20 sends entitlements to the subscribing application server 24. The sent entitlements may include all entitlements associated with services performed by the subscribing application server, a portion of all of the entitlements, or all of the entitlements. Alternatively, the sent entitlements may include only the entitlements that have changed since the last time entitlements were sent. The approved services in each received entitlement may not be contained in the hierarchical data structure of services. The processor 62 may be further configured to map the approved services in the received entitlements to the hierarchical data structure of services for storage in the database. In processing step 326, the subscribing application server 24 updates the entitlements stored in the subscribing application server 24.

The subscribing application server 24 validates that the given corporate customer user has permission to request the requested service. Validation includes, as depicted in processing step 328, analyzing the entitlement associated with the given corporate user to determine if the given corporate customer user has permission to request performance of the requested service on the specified account. This analysis may comprise locating the entitlement associated with the given corporate customer user and locating the requested service in the hierarchical data structure of the entitlement to determine if the user is indicated as having permission to initiate the requested service. In processing step 330, if the corporate customer user is determined to have permission, the subscribing application server 24 performs the requested service on the specified account. Performance of the requested service by the subscribing application server 24 may comprise sending an instruction to another computer or server to perform the requested service on the specified account.

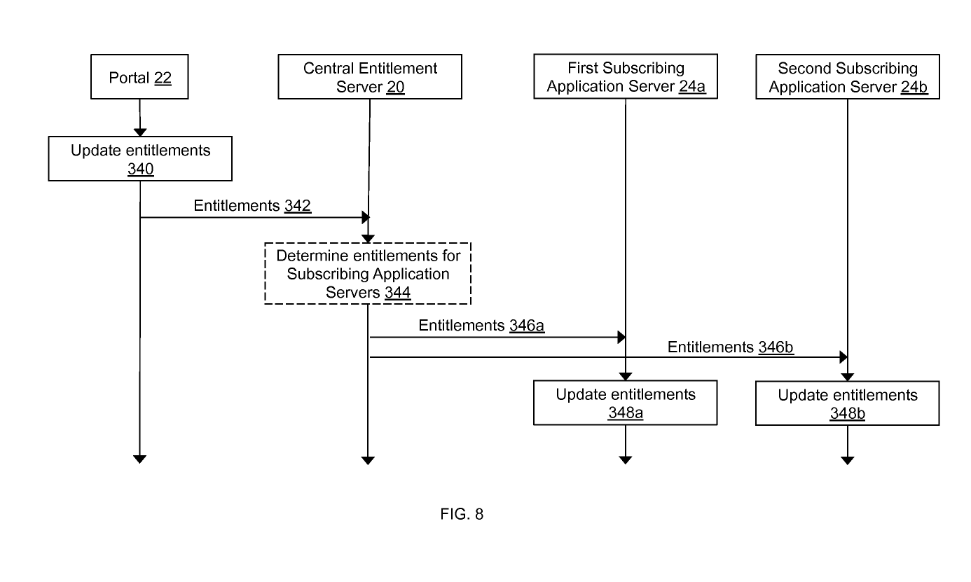

Turning to FIG. 8, exemplary steps of the method to send entitlement updates to two subscribing application servers are shown in a ladder diagram. In step 340, a user updates the entitlements. The entitlements may be updated on the web portal 22 or in any other suitable manner. In step 342, the central entitlement server 20 receives an update to the entitlements. The entitlement update may be received from the web portal 22. In optional processing step 344, the central entitlement server 20 determines the entitlements associated with the first subscribing application server 24a and the entitlements associated with the second subscribing application server 24b. In steps 346a and 346b, the central entitlement server 20 sends entitlements to the first subscribing application server 24a and the second subscribing application server 24b respectively. In step 348a, the first subscribing application server 24a updates the entitlements stored in the database of the first subscribing application server 24a. Similarly, in step 348b, the second subscribing application server 24b updates the entitlements stored in the database of the second subscribing application server 24b.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A central entitlement server for centrally storing and providing entitlements to subscribing application servers, each subscribing application server provides services to accounts held by corporate customers at a bank, the corporate customer designating at least one corporate customer user, the server comprising:
a database encoded to a non-transitory computer readable memory storing the entitlements, wherein each entitlement relates to at least one corporate customer user and specifies at least one associated account and at least one approved service the at least one corporate customer user has permission to request, wherein each at least one approved service is one of a plurality of possible services and is mapped to a hierarchical data structure of services, the hierarchical data structure of services comprising:
at least one product, wherein the at least one product is a root and each product is a parent of and links to at least one product function;
each product function linking to at least one function type, wherein the product function is a parent of the at least one function type; and
each function type linking to at least one action, wherein:
the function type is a parent of the at least one action;
each action corresponds to one of the plurality of possible services;
each of the plurality of possible services are represented by a corresponding action; and
each action is identified as approved if the at least one corporate customer user has permission to request the service corresponding to the action or disapproved if the at least one corporate customer user does not have permission to request the service corresponding to the action;
a processor configured to determine the entitlements associated with each subscribing application server and instruct a network interface to send each subscribing application server the entitlements stored in the database that are associated with the subscribing application server; and
the network interface configured to receive the instruction from the processor and send each subscribing application server the entitlements associated with the subscribing application server.

2. The central entitlement server of claim 1, wherein at least one action is a restricted action, each restricted action linking to at least one restriction, each restriction placing a limitation on performance of the restricted action.

3. The central entitlement server of claim 2, wherein the limitation placed by each restriction is at least one of a limit to the number of times the restricted action can be performed in a period of time, a prohibition on performing the restricted action when the restricted action affects a dollar amount above a threshold, and a requirement that the restricted action be approved by a corporate customer user having supervisory authority.

4. The central entitlement server of claim 1, wherein at least two function types are grouped into a function group.

5. The central entitlement server of claim 1, wherein at least two actions are grouped into an entry method.

6. The central entitlement server of claim 1, wherein at least two corporate customer users are associated with a user group, a group entitlement is associated with the user group, and the group entitlement specifies at least one associated account and at least one approved service the at least two corporate customer users have permission to request, wherein each at least one approved service is one of plurality of possible services stored in the hierarchical data structure of services.

7. The central entitlement server of claim 1, wherein the processor instructs the network interface to send each subscribing application server the entitlements associated with the subscribing application server at a scheduled time.

8. The central entitlement server of claim 1, wherein the processor instructs the network interface to send a given subscribing application server the entitlements associated with the given subscribing application server after the network interface receives a request from the given subscribing application server.

9. The central entitlement server of claim 1, wherein the processor instructs the network interface to send a given subscribing application server only the entitlements associated with the given subscribing application server that have changed since a previous sending of entitlements to the given subscribing application server.

10. The central entitlement server of claim 1, wherein when sending each subscribing application server the entitlements associated with the subscribing application server the network interface sends each entitlement as a separate data structure identifying the at least one corporate customer user, the at least one associated account, and the at least one approved service the at least one corporate customer user has permission to request.

11. A subscribing application server providing at least one service to a corporate customer, wherein a corporate customer user requests application of a given service of the at least one service to an account associated with the corporate customer at a bank, the subscribing application server comprising:
a network interface for receiving entitlements;
a database encoded to a non-transitory computer readable memory storing the entitlements, wherein each entitlement relates to at least one corporate customer user and specifies at least one associated account and at least one approved service the at least one corporate customer user has permission to request, wherein each at least one approved service is one of a plurality of possible services and is mapped to a hierarchical data structure of services, the hierarchical data structure of services comprising:
at least one product, wherein the at least one product is a root and each product is a parent of and links to at least one product function;
each product function linking to at least one function type, wherein the product function is a parent of the at least one function type; and
each function type linking to at least one action, wherein:
the function type is a parent of the at least one action;
each action corresponds to one of the plurality of possible services;
each of the plurality of possible services are represented by a corresponding action; and
each action is identified as approved if the at least one corporate customer user has permission to request the service corresponding to the action or disapproved if the at least one corporate customer user does not have permission to request the service corresponding to the action;
the network interface further configured to receive a service request from a given corporate customer user, wherein the service request includes a requested service to be performed on a specified account; and
a processor configured to:
access the entitlement stored in the database for the given corporate user to determine if the given corporate customer user has permission to request performance of the requested service on the specified account; and
if the given corporate customer user is determined to have permission, perform the requested service on the specified account.

12. The subscribing application server of claim 11, wherein at least one action is a restricted action, each restricted action linking to at least one restriction, each restriction placing a limitation on performance of the restricted action.

13. The subscribing application server of claim 12, wherein the limitation placed by each restriction is at least one of a limit to the number of times the restricted action can be performed in a period of time, a prohibition on performing the restricted action when the restricted action affects a dollar amount above a threshold, and a requirement that the restricted action be approved by a corporate customer user having supervisory authority.

14. The subscribing application server of claim 11, wherein at least two function types are grouped into a function group.

15. The subscribing application server of claim 11, wherein at least two actions are grouped into an entry method.

16. The subscribing application server of claim 11, wherein at least two corporate customer users are associated with a user group, a group entitlement is associated with the user group, and the group entitlement specifies at least one associated account and at least one approved service the at least two corporate customer users have permission to request, wherein each at least one approved service is one of plurality of possible services stored in the hierarchical data structure of services.

17. The subscribing application server of claim 11, wherein the processor is further configured to instruct the network interface to send a request for an entitlement update.

18. The subscribing application server of claim 17, wherein the processor instructs the network interface to send the request after the network interface receives the service request.

19. The subscribing application server of claim 17, wherein the processor instructs the network interface to send the request at a scheduled time.

20. The subscribing application server of claim 11, wherein the approved services in each received entitlement are not contained in the hierarchical data structure of services and the processor is further configured to map the approved services in the received entitlements to the hierarchical data structure of services for storage in the database.

21. A method for centrally storing entitlements in a central entitlement server and sending the entitlements from the central entitlement server to subscribing application servers, the subscribing application servers performing services on accounts at a bank based on the entitlements and received service requests, the method comprising:
sending entitlements, over a network from the central entitlement server, to the subscribing application servers, wherein each entitlement relates to at least one corporate customer user and specifies at least one associated account and at least one approved service the at least one corporate customer user has permission to request, wherein each at least one approved service is one of a plurality of possible services and is mapped to a hierarchical data structure of services, the hierarchical data structure of services comprising:
at least one product, wherein the at least one product is a root and each product is a parent of and links to at least one product function;
each product function linking to at least one function type, wherein the product function is a parent of the at least one function type; and
each function type linking to at least one action, wherein:
the function type is a parent of the at least one action;
each action corresponds to one of the plurality of possible services;
each of the plurality of possible services are represented by a corresponding action; and
each action is identified as approved if the at least one corporate customer user has permission to request the service corresponding to the action or disapproved if the at least one corporate customer user does not have permission to request the service corresponding to the action;
receiving, by at least one subscribing application server, a service request sent by a given corporate customer user, the service request including a requested service to be performed on a specified account; and
validating by the subscribing application server that the given corporate customer user has permission to request the requested service, wherein validation comprises:
analyzing the entitlement associated with the given corporate user to determine if the given corporate customer user has permission to request performance of the requested service on the specified account; and
performing the requested service on the specified account if the corporate customer user is determined to have permission.
